(19) United States
(12) Patent Application Publication
(10) Pub. No.: US 2005/0256722 A1
(43) Pub. Date: Nov. 17, 2005

(54) System and method for lossless audio encoding and decoding

(76) Inventor: Adam Leslie Clark, Melbourne (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/845,644

(22) Filed: May 14, 2004

(51) Int. Cl. G06F 17/00; G10L 19/02; G10L 21/00; G10L 19/00

(52) U.S. Cl. 704/500

(57) ABSTRACT

Audio information is encoded, sample by sample, by creating a table of encoded audio sample values in which redundant ones of the encoded audio sample values share common table entries. The encoding method may include comparing a current audio data sample to be encoded to previously encoded audio data samples to determine if the current audio data sample value is a redundant value, and if it is a redundant value, a pointer to the table location of the first occurrence of the redundant previously encoded audio data value is entered into the table of encoded audio sample values.

### FIELD OF THE INVENTION

The present invention relates generally to communications systems, and more specifically to lossless encoding and decoding of audio information.

### BACKGROUND OF THE INVENTION

Audio data may be digitized, encoded, and subsequently decoded in a manner which significantly decreases the number of bits necessary to represent the original audio information. Audio coding is an important part of many applications such as digital television transmission, audio/video conferencing, and audio file storage, etc.

In audio streaming applications, for example, audio data may be streamed from a network location, such as an Internet radio station, and decoded at a client machine. The audio data may be encoded at a network server and streamed via transmission over a communications channel to the client machine. For example, the data stream may be transmitted over a phone line, an integrated services digital network (ISDN) line, or the Internet.

In general, connection of a user interface device to the Internet may be made by a variety of communication channels, including twisted pair telephone lines, coaxial cable, and wireless signal communication via local transceivers or orbiting satellites. Most user interface device Internet connections are made by relatively low-bandwidth communication channels, mainly twisted pair telephone lines, due to the existing infrastructure of such telephone lines and the high cost of implementing a high-bandwidth infrastructure. In order to accommodate low bandwidth connections, a digital audio source (e.g., Internet radio provider) can use a lossy audio encoding/compression technique to stream audio information to users via the Internet. For example, MP3 (Moving Picture Experts Group-audio layer-3) encoding uses a lossy algorithm for compressing a sound sequence into a file about one-twelfth the size of the original file. Lossy compression trades a loss of audio quality for the opportunity of greater compression.

For standard voice data (e.g., news broadcast), the loss in sound quality using lossy compression may be acceptable to a user. For complex data, such as music, the loss in sound quality may be unacceptable and may affect the business of the digital audio source through losses in listener or subscription base and advertising.

### SUMMARY OF THE INVENTION

A method to encode audio data by using a lossless encoding process includes encoding, sample by sample, a plurality of audio data samples by creating a table of encoded audio sample values in which redundant ones of the encoded audio sample values share common table entries. In one embodiment of the present invention, the encoding process may include comparing a current audio data sample to be encoded to previously encoded audio data samples to determine if the current audio data sample value is a redundant value, and if it is a redundant value, a pointer to the table location of the first occurrence of the redundant previously encoded audio data value is entered into the table of encoded audio sample values.

In varying embodiments of the present invention, the plurality of audio data samples is a plurality of uncompressed digitized audio samples, or the plurality of audio data samples is a plurality of compressed digitized audio samples.

The method may also comprise transmitting the table of encoded audio sample values to a receiver, wherein the receiver decodes the table of encoded audio sample values to reproduce the plurality of audio data samples.

In one embodiment of the present invention, a system for encoding and decoding audio data includes an encoder to encode successive audio data samples from a digital audio file by creating an encoded audio table made up of encoded audio sample values, in which redundant ones of the encoded audio sample values share common table entries. The system further includes a decoder to decode the encoded audio table by using the common table entries to reconstruct the digital audio file. In one embodiment, the encoder is configured to compare a current audio data sample to be encoded to previously encoded audio data samples to determine if the current audio data sample value is a redundant value. The redundant value may be entered into the table as a pointer to the table location of the first occurrence of the previously encoded audio data value sharing the redundant value. Among varying embodiments of the present invention, the plurality of audio data samples may be a plurality of uncompressed digitized audio samples or a plurality of compressed digitized audio samples.

In one embodiment of the present invention, the methods described above are implemented in a set of computer readable instructions embodied on a computer-readable medium, which when executed by a computer processor cause the computer processor to execute a process in which, sample by sample, a plurality of audio data samples are encoded by creating a table of encoded audio sample values in which redundant ones of the encoded audio sample values share common table entries.

### BRIEF DESCRIPTION OF THE DRAWINGS

The present invention will be understood and appreciated more fully from the following detailed description taken in conjunction with the drawings in which:

FIG. 1 is a block diagram of an exemplary system for audio compression, transmission and playback, according to one embodiment of the present invention;

FIG. 2A illustrates an example of a sampled audio waveform that includes similar amplitude values for a plurality of samples;

FIG. 2B illustrates a digital audio table of sampled data points and corresponding binary values, according to one embodiment of the present invention;

FIG. 2C illustrates an encoded audio table including redundant table entries, according to one embodiment of the present invention;

FIG. 3A illustrates an encoded audio table as received by a decoder, including redundant table entries, according to one embodiment of the present invention;

FIG. 3B illustrates a decoded audio table, wherein a decoder populated the decoded audio table using redundant table entries.

### DETAILED DESCRIPTION

A system and method for encoding/decoding audio data are described. In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

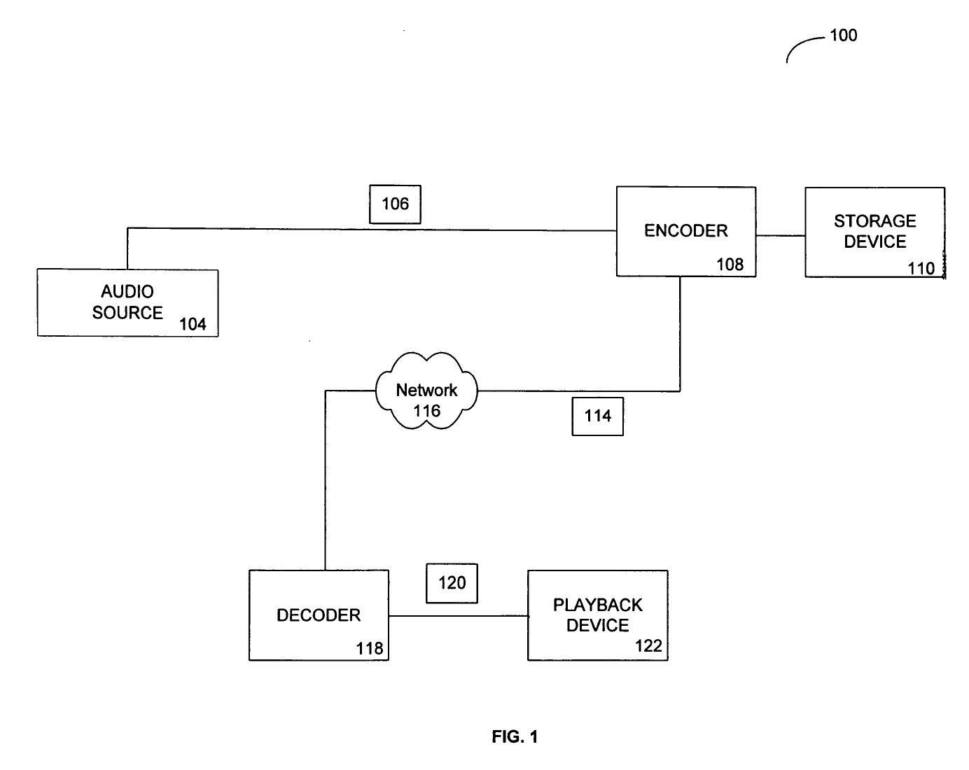

FIG. 1 is a block diagram of an exemplary system 100 for audio compression, transmission and playback, according to one embodiment of the present invention. Audio compression system 100 is designed to use a lossless encoding scheme to deliver high quality audio over low bandwidth transmission links (e.g., 9.6-56 kBps). Lossless encoding of this nature is characterized in that an original data stream, after compression, may be restored exactly to its original pre-encoded state. In one embodiment of the present invention, audio compression system 100 obtains audio data from an audio source 104, which may be any device capable of delivering digital audio data, such as a digital versatile disc (DVD), a compact disc (CD), a computer storage device, or digital audio tape. In another embodiment, the audio data is received from an audio source 104 delivering live audio data from an event such as a concert or sporting event.

The audio data 106 may include a header and is provided to an encoder 108. The header may include information regarding the audio sampling rate, the number of bits per sample, prior compression type, if used, and similar data that may be used by the encoder 108 or passed along to the decoder 118 within the encoded audio file 114.

Audio compression system 100 uses the encoder 108 to compress audio data 106 for streaming audio to a decoder at or near real-time. In another embodiment, the encoder 108 compresses audio data 106 for storing on storage device 110 for later transmission or local playback. The details of the encoding process performed by encoder 108 will be discussed below.

The encoder 108 produces a compressed or encoded audio file 114, which may include encoded audio data for all samples from the audio data 106 and header information for the encoded audio data, such as audio synch information. In another embodiment, a trailer within the encoded audio file 114 may be generated that may include information such as the audio synch information, prior compression type, if used, or a pointer identifying other audio data files to be decoded if the streamed data were segmented during the encoding process. The majority of the compressed audio file 114 is a table of encoded audio sample values based upon the received and encoded audio data 106.

The compressed audio file 114 may be transmitted over a network 116 to the decoder 118. The decoder 118 decodes the compressed audio file 114 to include a decompressed audio file 120 for audio playback via playback device 122. Playback device 122 may be any device accepting data such as a television, cellular phone, personal computer, personal digital assistant (PDA), automobile entertainment system, or other similar device capable of playing audio data. The process performed by the decoder 118 will be described in detail below.

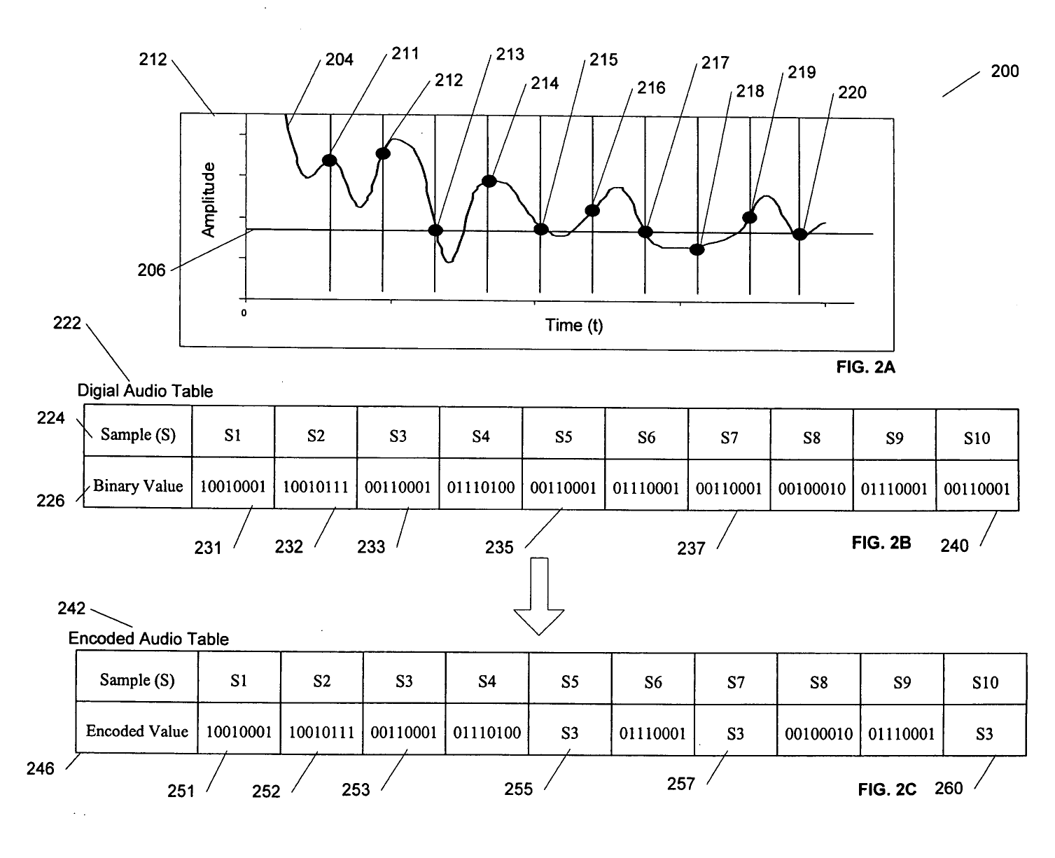

FIGS. 2A, 2B, and 2C illustrate the encoding of an audio sequence 200, according to one embodiment of the present invention. FIG. 2A illustrates sampling of audio waveform 204 at various points in time to produce a sampled audio waveform 212. This sampling produces a number of samples 211, 213, . . . 220, some of which may have identical (or sufficiently similar within a tolerance range) parameters (e.g., signal amplitude, frequency, etc.) for a plurality of samples. For example, in the illustration, audio waveform 204 is sampled at ten even intervals over its duration. The number of samples taken over a given time frame represents the sample rate. Typical sample rates range from 10 khz to 44 khz (10,000-44,000 times per second), depending on the desired acoustical range of sound to be duplicated.

In the illustration, for simplicity of explanation, the vertical axis represents the amplitude of the audio waveform 204 for any given instant of time. However, similar waveforms may be produced for any parameter or set of parameters of the audio waveform, in either time or the frequency domain. The present encoding techniques may be applied in either domain, with respect to any parameter or group of parameters. The sampled values are converted to binary values by such devices as analog to digital converters. The resolution, which represents the accuracy of the conversion, depends on the number of bits used to represent a sampled amplitude value. For example, an 8-bit conversion allows for 256 discreet amplitude values while 16-bit allows for 65,536 discreet amplitude values. The higher the resolution and/or sample rate, the more bandwidth required to transmit the encoded audio waveform and the more memory required to store the encoded audio waveform.

FIG. 2B illustrates a digital audio table 222 of sampled data points 211-220 as indicated in sample row 224 (S1-S10) and corresponding binary values of binary value row 226. For example, sample data point 211 corresponds with S1 and its associated binary value 231, and so on. As illustrated in FIG. 2A, amplitude value 206 indicates a common sample amplitude value for four of the ten sample points, specifically 213, 215, 217, and 220. These values correspond with the binary values 233, 235, 237, and 240 of digital audio table 222, respectively.

FIG. 2C illustrates an encoded audio table 242, according to one embodiment of the present invention. For each binary value of binary value row 226, a corresponding encoded value entry is entered in encoded value row 246 in encoded audio table 242. According to one embodiment, the encoder 108 populates the encoded audio table 242 sequentially, sample by sample. During encoding, if a particular binary value is a first occurrence of that value it is duplicated into the encoded audio table 242 in its entirety. For example, binary values 231, 232, and 233 are first occurrences of the binary sequences (10010001), (10010111), and (00110001), respectively, and are duplicated as shown by encoded values 251, 252, and 253. If, however, a binary value is determined to be redundant (that is identical or sufficiently similar) to a previously stored encoded value, the encoder 108 places a pointer to the previously encoded value in table 242 instead of duplicating the entire binary value. For example, binary values 235, 237 and 240 are equal to binary value 233. Instead of duplicating the value (00110001) into the encoded audio table 242 at each point, a pointer “S3” is written in encoded value locations 255, 257, and 260 corresponding to the duplicate binary values 235, 237, and 240. Because a pointer requires fewer numbers of bits than the entire binary value, the encoded audio table 242 is smaller in size than its corresponding digital audio table 222. As a result, the table consumes less physical memory and requires less bandwidth during transmission. In practical applications (e.g., music comprised of millions of samples), the decrease in memory and bandwidth consumption is dramatic due to the large number of samples being encoded.

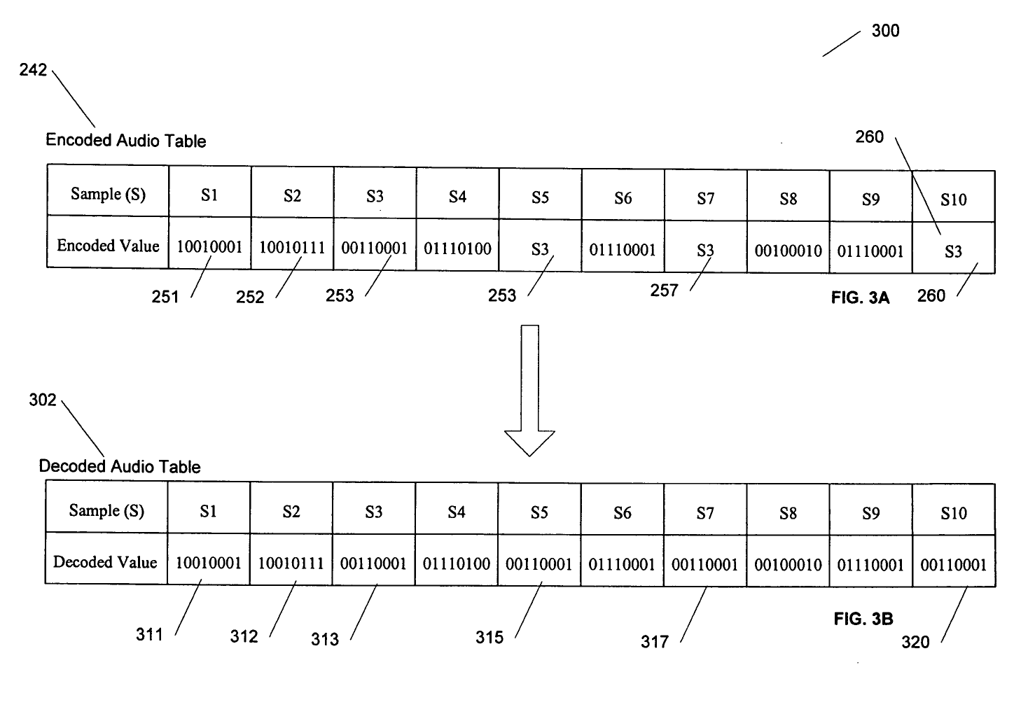

FIGS. 3A and 3B illustrate a decoding process 300, according to one embodiment of the present invention. FIG. 3A illustrates the encoded audio table 242 including the common pointer value “S3” in encoded value locations 255, 257, and 260, each pointing to the binary value 253 (00110001).

FIG. 3B illustrates a decoded audio table 302, wherein the decoder 118 populated the decoded audio table 302 by decoding the encoded audio table 242 using the common pointer value S3. For example, in decoding the encoded values 251, 252, and 253 (10010001, 10010111, 00110001), the decoder 118 duplicates these binary values into the decoded audio table 302, as illustrated by decoded values 311, 312, and 313. In decoding the pointer values (S3) of the encoded values 255, 257, and 260, the decoder inserts the binary value 313 (corresponding to table entry “S3”) into the decoded values 315, 317, and 320.

As previously discussed, because the decoded values are identical to (or sufficiently similar to, within a tolerance range) the pre-encoded values, the compression is lossless and thus the quality and integrity of the original sampled audio data is maintained.

Some portions of the detailed description above was presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, signals, datum, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

A system and method for encoding and decoding audio data have been described. It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method to encode audio data, comprising for each sample of a plurality of audio data samples creating a table of encoded audio sample values in which redundant ones of the audio data samples share common table entries.

2. The method of claim 1, further comprising comparing a current audio data sample to be encoded to previously encoded ones of the audio data samples to determine if the current audio data sample is a redundant audio data sample.

3. The method of claim 2, wherein if the current audio data sample is a redundant audio data sample a pointer to a location in the table of encoded audio sample values of a previous occurrence of an encoded audio data value corresponding to the redundant audio data sample is inserted in the table of encoded audio sample values in place of the redundant audio data sample.

4. The method of claim 1, wherein the plurality of audio data samples is a plurality of uncompressed digitized audio samples.

5. The method of claim 1, wherein the plurality of audio data samples is a plurality of compressed digitized audio samples.

6. The method of claim 1, further comprising transmitting the table of encoded audio sample values to a receiver.

7. The method of claim 6, further comprising decoding the table of encoded audio sample values at the receiver.

8. A system comprising:
an encoder to encode successive audio data samples from a digital audio file by creating a table of encoded audio sample values in which redundant ones of the audio data samples share common table entries; and
a decoder to create from the table of encoded audio sample values a decoded digital audio file for playback.

9. The system of claim 8, wherein the encoder is configured to compare a current audio data sample to be encoded to previously encoded audio data samples to determine if the current audio data sample value is a redundant audio data sample.

10. The system of claim 9, wherein if the current audio data sample is a redundant data sample, a pointer to a location of an occurrence of a corresponding previously encoded audio data value is inserted in the table of encoded audio sample values in place of the redundant data sample.

11. The system of claim 8, wherein the plurality of audio data samples is a plurality of uncompressed digitized audio samples.

12. The system of claim 8, wherein the plurality of audio data samples is a plurality of compressed digitized audio samples.

13. A set of computer readable instructions embodied on a computer-readable medium, which when executed by a computer processor cause the computer processor to execute a process comprising encoding, sample by sample, a plurality of audio data samples by creating a table of encoded audio sample values in which redundant ones of the audio data samples share common table entries.
